(19) United States
(12) Patent Application Publication
(10) Pub. No.: US 2005/0235256 A1
(43) Pub. Date: Oct. 20, 2005

(54) Web-site development tool

(76) Inventor: Mark Freydl, Newport, RI (US)

Correspondence Address: Steubing McGuinness & Manaras LLP, 125 Nagog Park Drive, Acton, MA, 01720, US

(21) Appl. No.: 10/747,973

(22) Filed: Dec. 30, 2003

Related U.S. Application Data
(60) Provisional application No. 60/436,892, filed on Dec. 30, 2002.

(51) Int. Cl. G06F 9/44

(52) U.S. Cl. 717/107

(57) ABSTRACT

A modular web site design system, method and apparatus includes a host web site that may be accessed by one or more clients. The host web site includes a plurality of functional and visual modules. Each client accessing the web site can select one or more of the modules for use in their web site. When a client has completed selection of web site modules, the host web site generates a package, including the modules and other information used to create the web site at the clients web site server. The package is received at the client web site, and a call from the host web site causes the client to be built. The functional, visual and navigational aspects of the web site are segregated from the content of the web site to allow for easy update of any of the web site elements.

### RELATED APPLICATIONS

This application claims priority under 35 U.S.C. §119 to provisional patent application Ser. No. 60/436,892, filed Dec. 30, 2002 by Mark Fredyl.

### FIELD OF THE INVENTION

This invention relates generally to the field of the world wide web and more particularly to a system and method for web page design, deployment and maintenance.

### BACKGROUND

For marketing and general commerce purposes, many business clients today are faced with the necessity of establishing an internet presence. In general, the internet presence is established by providing a web site which includes visual artifacts and functionality that is specific to the business. Typically, the visual artifacts and functionality are integrated with the business specific content. The web site may be located by a consumer in a variety of manners, including direct access to the business domain name, or via an internet search. Because the web-site is the consumers' interface with the business, it is important that it is visually pleasing, easy to navigate, and provides the functionality needed to adequately support the business model of the client.

Web-site design is a specialized field, and generally each business must engage either an individual web designer or a web design firm to build their web-site. In choosing whether to engage an individual web designer or a web design firm, the advantages and disadvantages of each must be weighed. While the individual web designer frequently is cheaper than the advertised web design firms, their code is personalized and it is frequently difficult to add to the code as the business desires to change the look, feel and functionality of its site. In contrast, although the web design firm may provide enhanced functional features for its site, the features frequently come at a cost. In addition, because the design firms service multiple different clients, the business may be forced into including certain undesired but stock visual artifacts on their page. Also, because the features provided by the web design firms are geared towards supporting multiple different types of clients, it is often difficult for the individual business to tweak or upgrade the available functionality to obtain exactly what they believe that they need to best reflect their business model to a consumer. In both instances, even if the client is able to upgrade functionality or visual artifacts of the web site, it is often difficult to upgrade the site because typical web site designs integrate business content with the web site components. Thus, during the upgrade, the web site may be undesirably unavailable to the consumer, thereby affecting business throughput. It would be desirable to provide a flexible, inexpensive web design tool that would provide enhanced functionality, flexibility and be easily up-gradable to and end user client.

### SUMMARY

A web-site design architecture is provided that apportions certain aspects of web site content into discrete components. The discrete components may include, for example, functional modules, graphic user interface, navigation trees, etc. The components are provided through a flexible client interface at a host that permits a client to pick and choose which components are to be presented in the finished web site design. When a client completes component selection, the group of components are packaged together and forwarded to the client web site server. At the client web site server, the components are assembled and linked to the client content to provide the desired web presence. With such an arrangement, a client can pick and choose the desired web site features and functionality at minimal cost.

In addition, the architecture facilitates the upgrade of modules, graphic interfaces or web site features, by providing the ability to add version numbers to one or more web site components. As the versions are upgraded at the host, the host may signal each client that an upgrade is available, package the upgrade and forward it to the client. Because client content is merely linked to the web site components, rather than integrated into their functionality, seamless upgrades of the web site may be achieved without undesirably affecting the productivity of the clients' business.

According to one aspect of the invention, a web site design tool includes a plurality of design modules, an interface enabling selection, by a user, of different ones of the design modules of the plurality to be included in a web site, the selected design modules forming a package of design modules; and means for forwarding the package of design modules to a client web site server.

According to another aspect of the invention, a method for designing a web site for a client including the steps of selecting a design module from a plurality of design modules at a graphic user interface and forwarding the design module to the client.

According to a further aspect of the invention, a computer includes a memory storing a plurality of web pages associated with a web site, the computer comprising a directory structure, identifying locations of modules that are used to provide functional and visual attributes for the web pages, content for display on the web site; and means for linking the content to the web pages.

According to a further aspect of the invention, a method for updating a module at a client including the steps of receiving, at the client, a module having an identifier, determining whether the module is an existing module at the client. Responsive to a determination that the module is an existing module at the client, the method includes the step of comparing a version number of the existing module to a version number of the received module. Responsive to the version number of the received module exceeding the version number of the existing module, the method includes the step of storing the received module in memory and updating a pointer in a data structure that points to the existing module to point to the received module.

According to another aspect of the invention, in a modular web design system wherein web sites are comprised of a plurality of linked modules, a method for updating one of the modules including the steps of forwarding an updated version of one of the modules to a client using the one of the modules; storing, at the client, the updated version of the one of the modules; replacing, in a directory structure at the client, a first pointer to an existing version of the one of the modules with a second point to the updated version of the one of the modules.

With such an arrangement, a system is provided which is modular nature, has the ability to identify upgraded versions of modules, with the ability to spawn a web site at a user location. In addition, the separation of user content from functional and design modules provides the ability to make enable upgrades to a large number of web sites in an automated fashion.

### BRIEF DESCRIPTION OF THE DRAWINGS

FIG. 1 is a network diagram provided to illustrate communication links between a host server and a client seeking to use the web site design system and method of the present invention;

FIG. 2 is a block diagram showing exemplary components that may be included at a host server to provide a web site component package according to the present invention;

FIG. 3 is a flow diagram illustrating exemplary steps that may be performed at the host server to generate the web site component package of FIG. 2;

FIG. 4 is a block diagram illustrating exemplary components that may be included a client web site server;

FIG. 5 is a flow diagram illustrating exemplary steps that may be performed to assemble a web site using the web page component package of FIG. 3;

FIG. 6 is a flow illustrating exemplary steps that may be used to update modules at a web site when a new version of the module is made available; and

FIG. 7 is one representation of a graphical user interface that may be provided at the host web-site for selecting the functional or visual modules for use in building a client web site.

### DETAILED DESCRIPTION

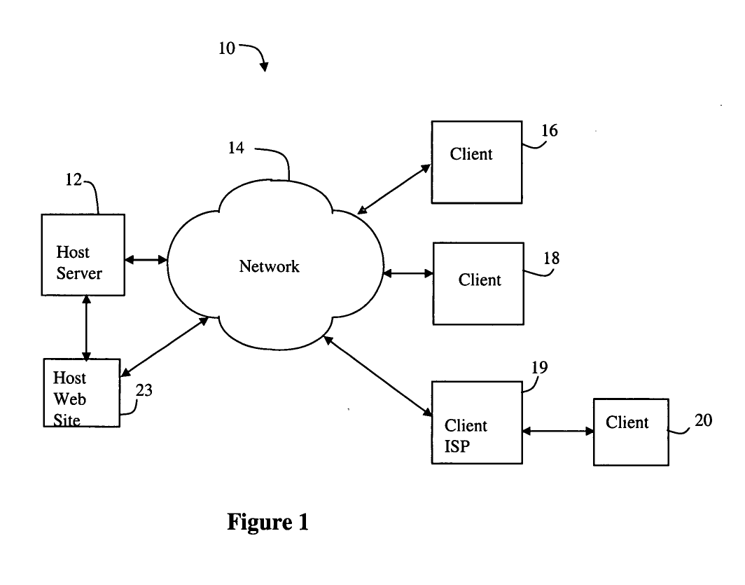

Referring now to FIG. 1, a network 10 in which the web page architecture of the present invention may be used is shown to include a host server 12 coupled via a network transport medium 14 (such as the Internet) to a number of clients 16, 18 and 20. Client 20 is coupled to the network 14 via an Internet Service Provider 19. As it is known in the art, the Internet provides a transport medium that enables world-wide connectivity between clients. Many Internet Service Providers (ISPs) may be coupled to the client, and provide enhanced internet access functionality to a large group of clients. In some embodiments, the ISP may host the client's web site. In other embodiments, the client may host their own web page. Although the present invention deals with providing a web site for a particular client, it is important to note that the present invention is not limited to the hosting of a client's web site at any particular point in the network.

Each web site is composed of a number of web pages. Each web page may include any one of a group of text, graphics, video, audio components or other attributes. Web pages are generally described using Hyper Text Mark-Up Language (HTML), with HTML tags specifying the format and organization of items on the web page. A web browser (such as Internet Explorer or Netscape) translates the HTML pages into elements that may be represented on a user interface.

According to one aspect of the invention, it is recognized that the web-site is actually a collection of software modules, each of which is a program that is used to provide some sort of feature to the web site. For example, functional modules may be used to provide utility to the web site. The utilities that may be provided to the web site could include, for example, a search utility, a security utility, news report manager, online user forums, banner advertising management system, an e-commerce storefront, user surveys, a searchable database of downloadable files, classifieds, a membership system, and the like etc. In addition, each web site is composed of a number of visual modules, which define the overall visual attributes of various objects that are displayed on a web page including page templates, color scheme, associated images, Flash objects (an interactive technology from Macromedia), Java applets and other elements required to define the look and feel of the web site. In addition, associated with each web site is a navigation module, which maps together the various pages on the web site.

The architecture of the present invention is comprised of a web site and server architecture which together permit multiple clients to easily custom design their own web site. Modules that may be used to design the sites are generated and stored at the host server 12, where in one embodiment the host server may be for example a local area network used for a business, such as that used by Armadyne, of Middletown Rhode Island. Associated with the host server is a web site 23, such as the Armadyne web site, which displays the modules that are available to a client seeking to build a web site. Armadyne provides a hosted publishing platform for new media designers to rapidly deploy and maintain robust web sites with evolving applications, online content management, information architecture tools, and a scalable modular framework.

As noted above, the host web site may not be resident on the host server, and the present invention is not limited to such an arrangement. As will be described in more detail below, modules are generated and stored at the host server. When the modules are ready for use, either the module, or a pointer to the module, is forwarded to the host web site. A client accesses the host web site and selects desired modules for building the web page. The process running at the host web site packages the modules and forwards them to the client. The client web site is then automatically built at the client web site server.

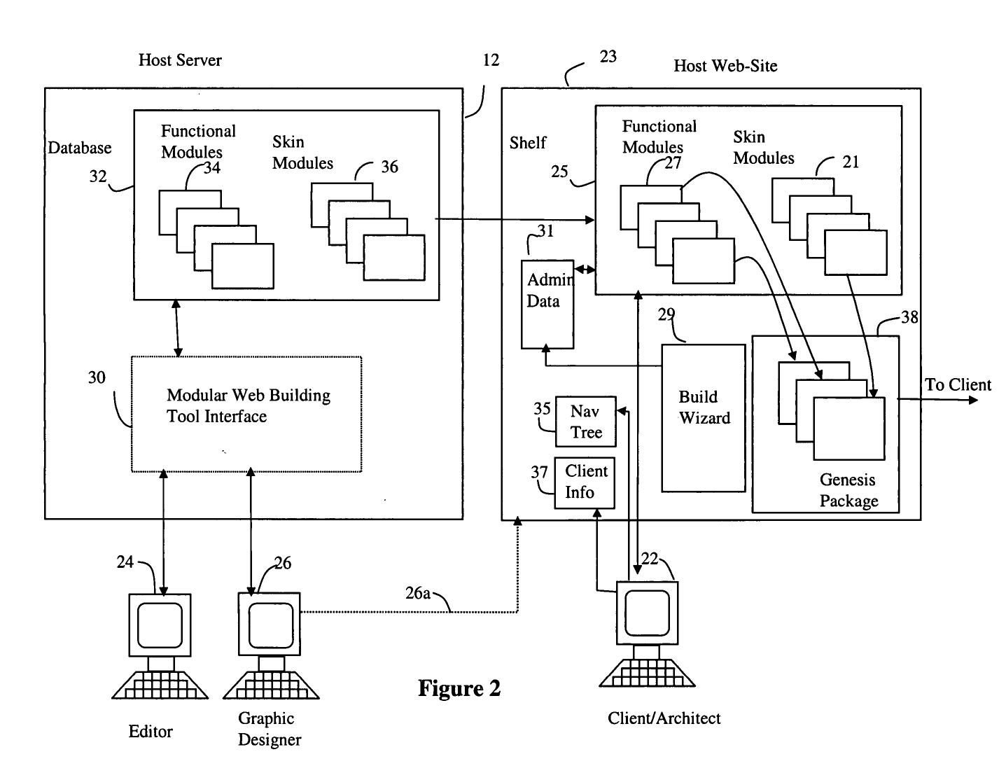

For example, referring now to FIG. 2, exemplary components that may be included in a host server 12 and a host web site 23 for implementing the present invention are shown. A database of modules is shown to include a set of functional modules 34 and a set of skin modules 36. Each of the modules is comprised of program code that is generated by a third party such as a graphic designer 26 or an editor 24. In one embodiment, a version number is advantageously associated with each module that is stored in the shelf to permit upgrade of the modules at the client in a manner that will be described later herein. As described above, the program code could be any code that is used to perform any function or represent a set of visual attributes, and the present invention is not limited to the provision of any particular code.

Disposed between the database 32 and the editor is an optional modular web building tool interface 30. In one embodiment, the modular web building tool interface is used to translate input from the editor or the graphic designer into software modules having a desired structure. The desired structure could be, for example, a certain version of HTML, object oriented code, etc. For example, a editor could provide certain programming code for updating banner contents. The interface then translates the indicated selections into the software modules, hyper-text pages, etc. Alternatively, the editor or graphic designer could develop the software code locally, and then forward straight to the database 32. Either way, in the embodiment above, development and enhancement of the modules takes place at the host server 12. Each release of a module is tracked in the database, for example by storing meta-data for each module. When the module is ready for use by a client, in one embodiment it is packaged in a file, the version number of the module is incremented, and the meta-data associated with the module is updated with the new version number. Either the file itself, or a pointer to the file, is then forwarded to the host web site 23.

In an alternate embodiment, graphical user interfaces (GUIs) could be developed locally on the machine of the graphic designer 26. When the GUI is ready for use, the graphic designer packages the GUI files, connects to the host server or host web-site server, and uploads the GUI, either to the database 32 or directly to the shelf 25. Each time the GUI is uploaded, the version number of the GUI is incremented, and the module is stamped with the latest version number. This ability is indicted by the dashed line 26a in FIG. 2.

The web-site 23 is shown to include a database similar to the database 32, which includes only modules that have been forwarded to the web site. The database at the web-site is referred to as the ‘shelf’ for clarity purposes. The architect selects different modules from the shelf to design the client web site. In addition, the architect of the web site can populate the site's navigation tree 35 (i.e., how the individual web pages of the web site are to be interconnected) and input the general site administration information in the client information database 37. Such administration information includes company name and contact information, and the physical scale of the site (used to choose the hosting plan, based on how much visitor traffic they expect on the site, whether certain modules they have loaded require a more robust database system, and whether they intend to be uploading large amounts of data, such as a video library).

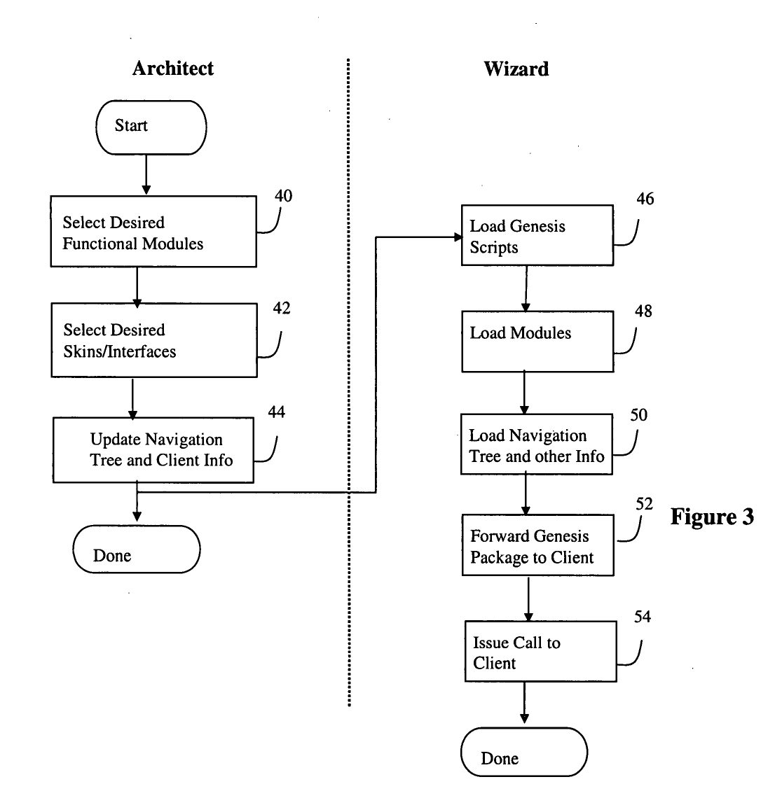

For example, referring now to FIG. 3, exemplary steps that may be at the host web-site using the present invention are shown. Note that some steps are performed by architect 22, and some are performed by the build wizard 29. At step 40, the architect selects all the functional modules, and at step 42 all the skins. At step 44, the navigation tree and the client administration information is added to the database. When the architect has selected all of the functional modules, graphics, navigation tree and other features of the site, the component modules are packaged together by build wizard 29 in a folder referred to hereinafter as the genesis package 38. At step 46, the wizard 29 first loads a set of genesis scripts into the genesis package. The series of script files perform the genesis operations on the client web-site, allowing it to essentially “hatch” on the new server At step 48, all selected modules are loaded into the genesis package. At step 50, the navigation tree and other client information are also loaded into the genesis package. The package is then forwarded, at step 52, to the client web address indicated by the architect. The genesis scripts are then set in motion by an http call issued at step 54 from the host web-site server, and the genesis processes of creating a new site, adding modules, adding skins or updating the like is begun at the client.

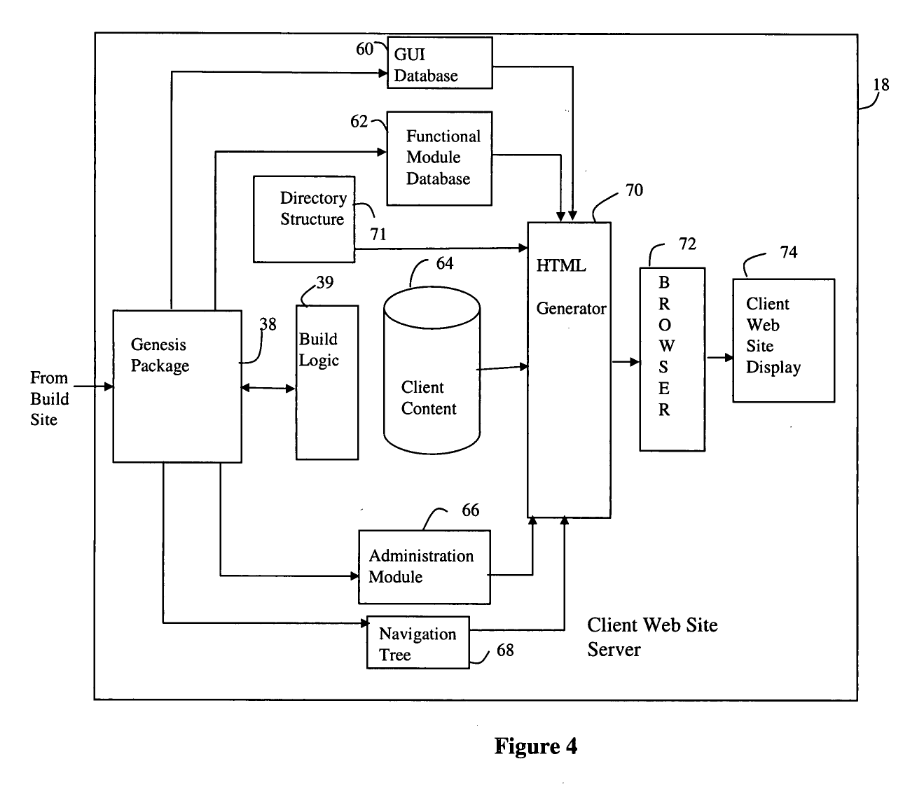

Referring now to FIG. 4, exemplary components that may be included at a client web site server are shown. The genesis package 38 is coupled to build logic 39, which basically operates in response to the call from the host web site server to execute the genesis scripts from the genesis package 38 to appropriately disassemble components from the package into a GUI database 60, a functional module database 62, an administration module 66 and a navigation tree 68. A directory structure 71 is used to identify the location of each of the modules within memory on the client web site server, in one embodiment using object oriented programming techniques. Each of the modules are accessed by the HTML generator, which generates web pages based on the contents of the modules. In addition, the HTML generator is directly coupled to the client content 64, which is a database of client content stored on the client web server. Note that in the present invention the content is not integrated with any of the functional modules, thereby facilitating seamless updates to any of the other modules 60, 62, 66 and 68. Coupled to the HTML generator 70 is the browser, which provides a visual translation of the web pages on the client's web site display 74.

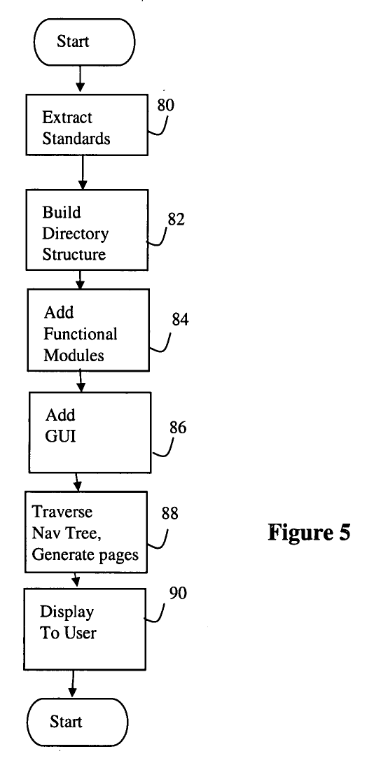

Referring now to FIG. 5, a flow diagram illustrating exemplary steps that may be performed when installing a new client web site. At step 80, standards are extracted from the genesis package. The standards are files or scripts that are shared by different modules. At step 82, the directory structure for the web-site is built. In one embodiment, in an object oriented system, the directory structure may be used to allocate different modules to different object classes. References to the modules then may be made by referencing the appropriate class of objects, then the object within the class. The directory structure may also include data from the navigation tree, to indicate how various objects are mapped between different web pages. The directory structure includes classes for the administrative module, visual modules and functional modules.

At step 84, once the directory structure has been defined, administrative modules and the functional modules are added to the directory. At step 86, the visual modules, or graphical user interface (GUI) is added to the directory. At step 88, the navigation tree is traversed, and all of the HTML pages are generated. At step 90, the newly created web-site is displayed to the user.

Thus, a method and apparatus has been shown and described that enables a client to build a customized web site in a flexible and inexpensive manner. The architecture of the web site design tool modularizes the web site components, enabling the client to more easily pick and choose only those elements that they desire on their site. As mentioned previously, the modularization of the web-site components also facilitates updating of the various modules, because the client content is segregated from any of the web-site components. Thus, should the client desire to modify one of the web-site components, the modification can occur without having to disassemble the existing web site.

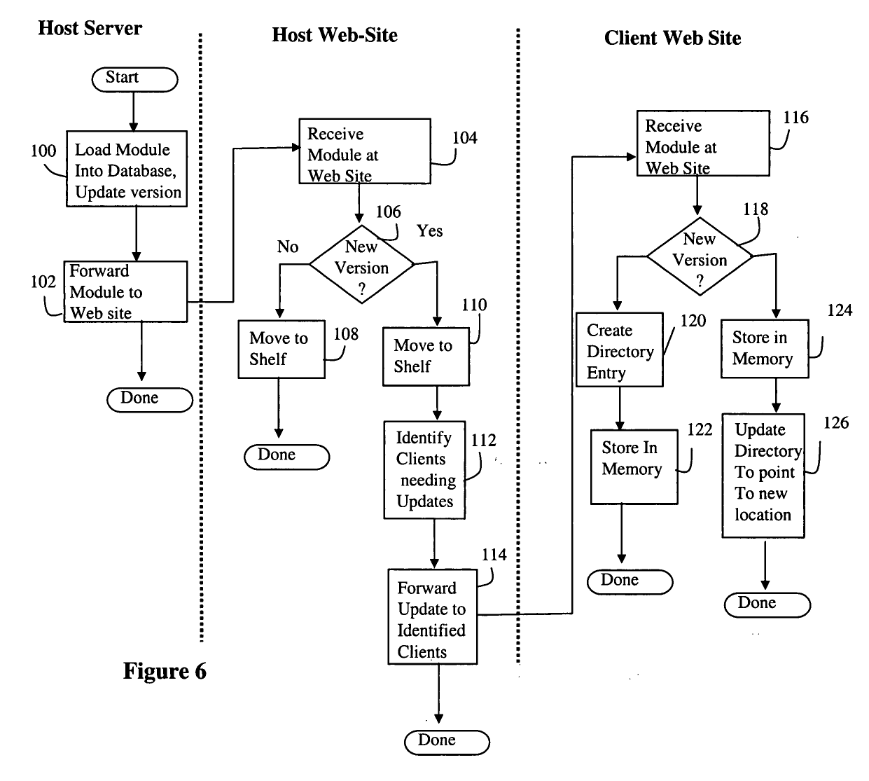

For example, referring now to FIG. 6, a flow diagram will now be described to illustrate exemplary steps that may be taken in the present invention to update modules at a client's web site. The flow diagram is shown apportioned into different sections, illustrating different operations performed at the host server, host web-site and client web site to facilitate the upgrade.

At step 100, a module is loaded into database 32, and the version number associated with the module is updated. The module is then made available to the host web-site at step 102. At step 104, the module is received at the host web site, and at step 106 it is determined, by the host web site, whether the module is an upgrade of an existing module, or is a new module. This determination can be made by examining the meta-data associated with the module, in particular a name of the module and a version number associated with the module. If it is a new module, i.e., a module having a name that is unique to the host web-site, then the module is merely moved onto the shelf at step 108. Otherwise, after the module is moved onto the shelf, at step 112 the host web-site identifies any clients that currently have the module integrated into their web-site design. This data can be determined by examination of the admin data table 31 (FIG. 2), which includes, as stated above, a name of each module and identifiers of each client that has selected the module and been forwarded the module in a genesis package.

Once the clients have been identified, at step 114, genesis packages are generated and forwarded to each identified client, where the genesis package includes only the genesis scripts and the new version of the module.

At step 116, at one of the identified client web-sites, the module is received at the web site. At step 118, it is determined by the web site whether the module is new to the web site, or merely a new version of an existing web site module. If it is a new module, then at step 120 an entry is generated in the directory structure for the new module, and at step 122 the module is copied to memory. Otherwise, if it was determined at step 118 that the module is a new version of an existing module, then at step 124 the module is stored in memory. At step 126, the existing directory structure pointer for the module is then updated to reflect the memory address of the updated version of the module. Alternatively, the updated module may simply write over the existing module. Thus, the next time that the module is invoked, the web-site seamlessly transitions over to the new version of the module, without causing any downtime of the web-site to be incurred.

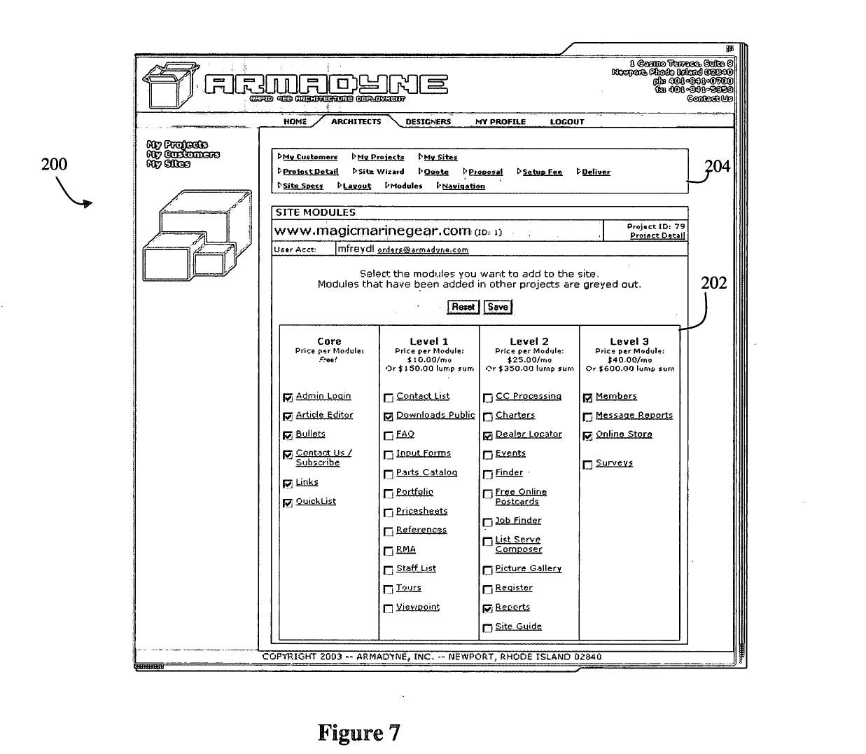

Referring now to FIG. 7, an exemplary graphical user interface 200 that may be used at the host web site to select functionality and visual attributes of a web site is shown. In the embodiment of FIG. 7, the optional modules are organized by cost, and are selected by the user by checking the box next to the desired functionality. A menu 204 provides a number of functions that can be executed by the user to view the selected layout, cost out the selected options, etc. Different pages are available to architects, designers, with the ability to switch between projects and sites. It is understood that FIG. 7 illustrates only one method by which the functional modules may be represented to a user, and the present invention is not limited to any particular layout, arrangement or selection of visual attributes.

Accordingly, a straightforward, customizable and upgradeable web-site design architecture, method and system has been shown and described with reference to several figures. FIGS. 1, 2 and 4 illustrated various components that may be included in the system, however it should be noted that the components were shown for discussion purposes only. Different delineation of functions or structural elements may be used without affecting the overall spirit of the invention. In addition, FIGS. 3, 5 and 6 were flowchart illustrations of methods, apparatus (systems) and computer program products according to an embodiment of the invention. It will be understood that each block of the flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that the system may be embodied using a variety of specific command structures. Accordingly, the invention should not be viewed as limited except by the scope and spirit of the appended claims.

1. A web site design tool comprising:
a plurality of design modules;
an interface enabling selection, by a user, of different ones of the design modules of the plurality to be included in a web site, the selected design modules forming a package of design modules; and
means for forwarding the package of design modules to a client web site server.

2. The web site design tool of claim 1, wherein the plurality of design modules includes visual modules and functional modules.

3. The web site design tool of claim 1 wherein the interface is a graphical user interface.

4. The web site design tool of claim 1, wherein the design modules include a navigation tree for indicating a relation of web pages in the web site.

5. The web site design tool of claim 1, wherein the design modules include administration modules for administering the web-site.

6. A method for designing a web site for a client including the steps of
selecting a design module from a plurality of design modules at a graphic user interface; and
forwarding the design module to the client.

7. The method of claim 6, wherein the design module is a graphical user interface.

8. The method of claim 6 wherein the design module is a functional module.

9. A method of building a web site at a client web site server including the steps of:
receiving, from a host web server, a plurality of design modules;
building a directory structure for the plurality of design modules;
building web pages for the web site in response to the directory structure, the step of building including linking content to the web pages.

10. A computer comprising:
a memory storing a plurality of web pages associated with a web site, the computer comprising a directory structure, identifying locations of modules that are used to provide functional and visual attributes for the web pages,
content for display on the web site; and
means for linking the content to the web pages.

11. A method for updating a module at a client including the steps of:
receiving, at the client, a module having an identifier;
determining whether the module is an existing module at the client;
responsive to a determination that the module is an existing module at the client, comparing a version number of the existing module to a version number of the received module;
responsive to the version number of the received module exceeding the version number of the existing module, storing the received module in memory and updating a pointer in a data structure that points to the existing module to point to the received module.

12. In a modular web design system wherein web sites are comprised of a plurality of linked modules, a method for updating one of the modules including the steps of:
forwarding an updated version of one of the modules to a client using the one of the modules;
storing, at the client, the updated version of the one of the modules;
replacing, in a directory structure at the client, a first pointer to an existing version of the one of the modules with a second point to the updated version of the one of the modules.
